(19) United States
(12) Patent Application Publication
(10) Pub. No.: US 2022/0404102 A1
(43) Pub. Date: Dec. 22, 2022

(54) VAPOR CHAMBER HAVING ADHERING CONFIGURATION AND MANUFACTURING METHOD THEREOF

(71) Applicant: MIRLE AUTOMATION CORPORATION, Hsinchu (TW)

(72) Inventors: CHIN-CHANG HUANG, HSINCHU (TW); CHUN-CHIEH LU, HSINCHU (TW); CHI-KANG TSAI, HSINCHU (TW)

(21) Appl. No.: 17/825,005

(22) Filed: May 26, 2022

Related U.S. Application Data
(60) Provisional application No. 63/211,156, filed on Jun. 16, 2021.

(30) Foreign Application Priority Data
Jan. 19, 2022 (TW) 111102092

(51) Int. Cl. F28D 15/04

(52) U.S. Cl. CPC F28D 15/04

(57) ABSTRACT

A vapor chamber having an adhering configuration and a manufacturing method thereof are provided. The manufacturing method includes: a dispensing step implemented by forming a ring-shaped adhesive onto an inner surface of a first metallic sheet; a filling step implemented by filling a working liquid in a space jointly defined by the inner surface of the first metallic sheet and the ring-shaped adhesive; a bonding step implemented by bonding the first metallic sheet and a second metallic sheet together in a vacuum chamber through the ring-shaped adhesive, so as to form a semi-finished product that defines an enclosed thermal flow space therein, in which the working liquid is arranged in the thermal flow space; and a solidifying step implemented by placing the semi-finished product in a solidifying environment so as to solidify the ring-shaped adhesive to form a sealing frame.

### CROSS-REFERENCE TO RELATED PATENT APPLICATION

This application claims the benefit of priority to Taiwan Patent Application No. 111102092, filed on Jan. 19, 2022. The entire content of the above identified application is incorporated herein by reference.

This application claims priority to the U.S. Provisional Patent Application Ser. No. 63/211,156 filed on Jun. 16, 2021, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a vapor chamber, and more particularly to a vapor chamber having an adhering configuration and a manufacturing method thereof.

### BACKGROUND OF THE DISCLOSURE

A conventional vapor chamber is limited by the existing technology in terms of its configuration and manufacturing method, so as to be difficult to be further improved in these aspects. The manufacturing method of the conventional vapor chamber can, for example, include the following steps. Two metallic sheets are soldered to each other in an atmospheric environment, and a gas hole is formed in one of the two metallic sheets; through the gas hole, a gas suction process is performed to suction gas out of a space between the two metallic sheets, and liquid is then injected into the space through an injection pipe; and the gas hole and the injection pipe are sealed to enclose the space, so as to form the conventional vapor chamber. However, the manufacturing method of the conventional vapor chamber involves complicated processes, and a low pressure cannot be established in the conventional vapor chamber.

### SUMMARY OF THE DISCLOSURE

In response to the above-referenced technical inadequacies, the present disclosure provides a vapor chamber having an adhering configuration and a manufacturing method thereof to effectively improve on the issues associated with conventional vapor chambers.

In one aspect, the present disclosure provides a manufacturing method of a vapor chamber having an adhering configuration. The manufacturing method includes a dispensing step, a filling step, a bonding step, and a solidifying step. The dispensing step is implemented by forming a ring-shaped adhesive onto an inner surface of a first metallic sheet. The filling step is implemented by filling a working liquid in a space jointly surrounded by the ring-shaped adhesive and the inner surface of the first metallic sheet. The bonding step is implemented by using the ring-shaped adhesive to bond the first metallic sheet and a second metallic sheet together in a vacuum chamber, so as to form a semi-finished product and to jointly define an enclosed thermal flow space that accommodates the working liquid therein. The solidifying step is implemented by placing the semi-finished product in a solidifying environment to solidify the ring-shaped adhesive to form a sealing frame.

In another aspect, the present disclosure provides a vapor chamber having an adhering configuration. The vapor chamber includes a first metallic sheet, a second metallic sheet, a sealing frame, and a working liquid. The second metallic sheet faces toward and is spaced apart from the first metallic sheet. The sealing frame is ring-shaped and has two ring-shaped connection surfaces that are respectively arranged on two opposite sides thereof. The two ring-shaped connection surfaces are gaplessly connected to the first metallic sheet and the second metallic sheet, respectively, so that the sealing frame, the first metallic sheet, and the second metallic sheet jointly define an enclosed thermal flow space. The working liquid is located in the thermal flow space.

Therefore, the manufacturing method of the vapor chamber having the adhering configuration provided by the present disclosure is implemented by using the ring-shaped adhesive to bond the first metallic sheet and the second metallic sheet in the vacuum chamber, so that the thermal flow space can be maintained at a low pressure value (e.g., a value less than 50 Pa). Accordingly, gas suction does not need to be performed in the thermal flow space of the vapor chamber, thereby effectively simplifying the existing processes and structures relating to the conventional vapor chamber.

Moreover, in the vapor chamber having the adhering configuration provided by the present disclosure, the first metallic sheet and the second metallic sheet can be bonded by being gaplessly connected to the sealing frame, thereby simplifying the existing structure, effectively reducing a material and manufacturing cost, and increasing a production effectiveness thereof.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a manufacturing method of a vapor chamber having an adhering configuration according to a first embodiment of the present disclosure;

FIG. 2 is a perspective view showing a surface treatment step of FIG. 1;

FIG. 3 and FIG. 4 are perspective views showing a dispensing step of FIG. 1;

FIG. 5 is a perspective view showing a filling step of FIG. 1;

FIG. 6 is a cross-sectional view taken along line VI-VI of FIG. 5;

FIG. 7 and FIG. 8 are perspective views showing a bonding step of FIG. 1;

FIG. 9 is a perspective view showing a solidifying step of FIG. 1;

FIG. 10 is a perspective view of the vapor chamber having the adhering configuration according to the first embodiment of the present disclosure;

FIG. 11 is a cross-sectional view taken along line XI-XI of FIG. 10;

FIG. 12 is a perspective view showing the dispensing step of the manufacturing method according to a second embodiment of the present disclosure; and

FIG. 13 is a cross-sectional view of the vapor chamber having the adhering configuration according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

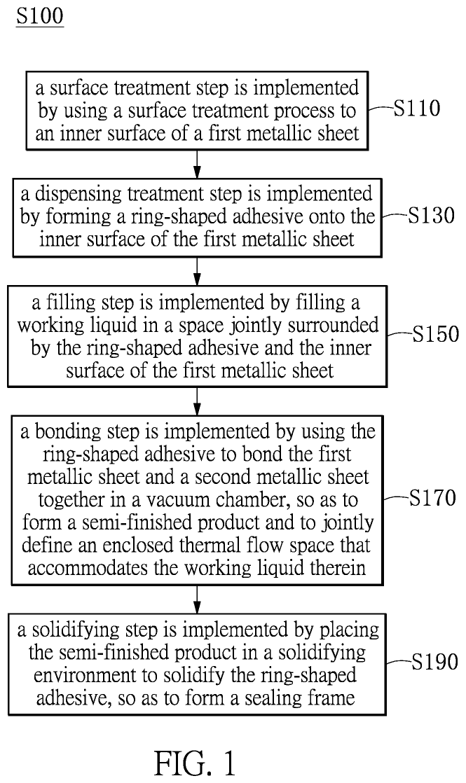

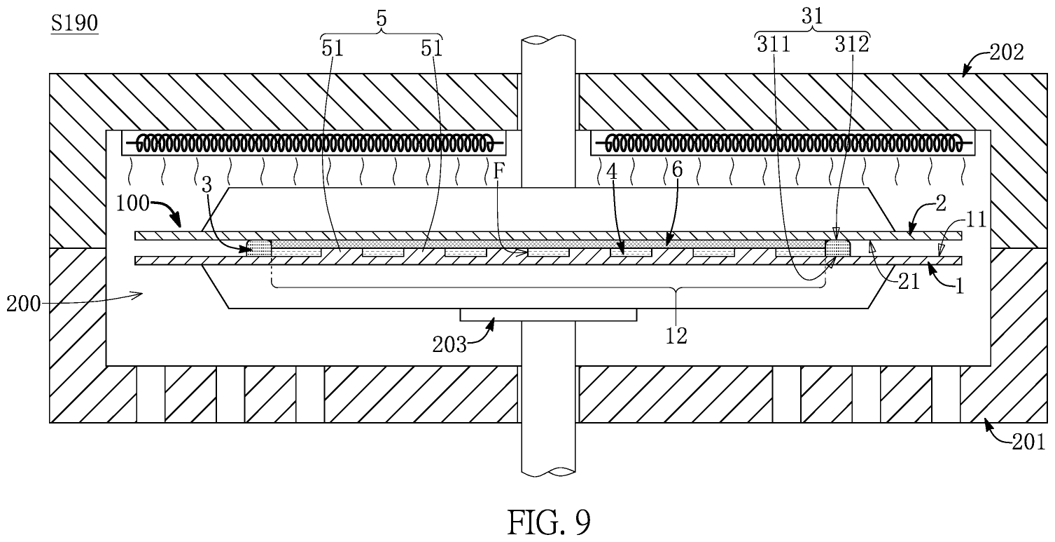

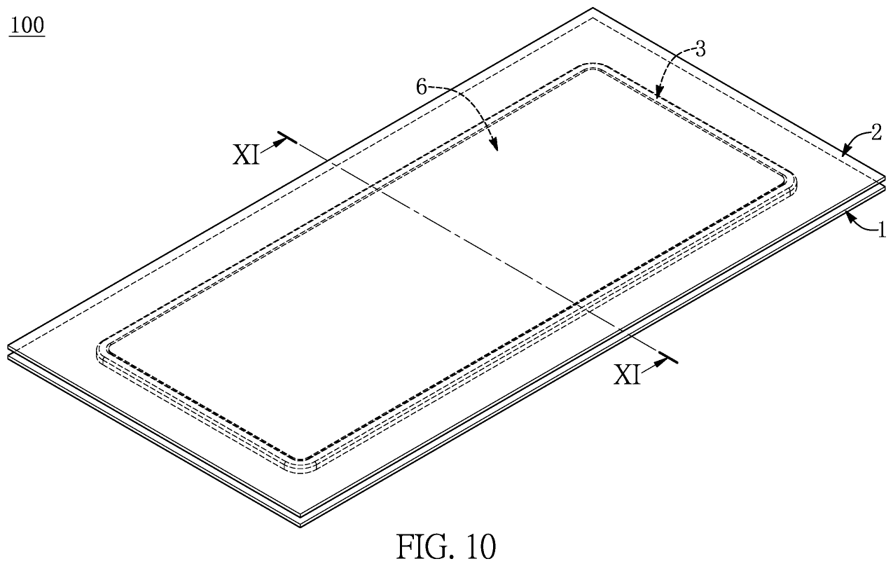

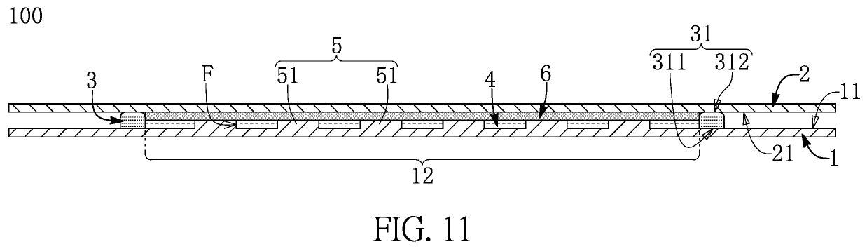

Referring to FIG. 1 to FIG. 11, a first embodiment of the present disclosure provides a vapor chamber 100 having an adhering configuration and a manufacturing method S100 thereof. The vapor chamber 100 in the present embodiment is manufactured by implementing the manufacturing method S100, but the present disclosure is not limited thereto. For example, in other embodiments of the present disclosure, the vapor chamber 100 can be manufactured by implementing other methods.

Moreover, in order to clearly describe the present embodiment, the following description describes the manufacturing method S100, and then describes the structure and connection relationship of each component of the vapor chamber 100.

As shown in FIG. 1 to FIG. 10, the manufacturing method S100 sequentially includes a surface treatment step S110, a dispensing step S130, a filling step S150, a bonding step S170, and a solidifying step S190. It should be noted that the manufacturing method S100 in the present embodiment is described by implementing the above steps S110-S190, but the present disclosure is not limited thereto.

For example, in other embodiments of the present disclosure, any one of the steps S110-S190 can be adjusted or changed according to design requirements (e.g., the surface treatment step S110 can be omitted). The following description describes each of the steps S110-S190 of the manufacturing method S100 of the present embodiment.

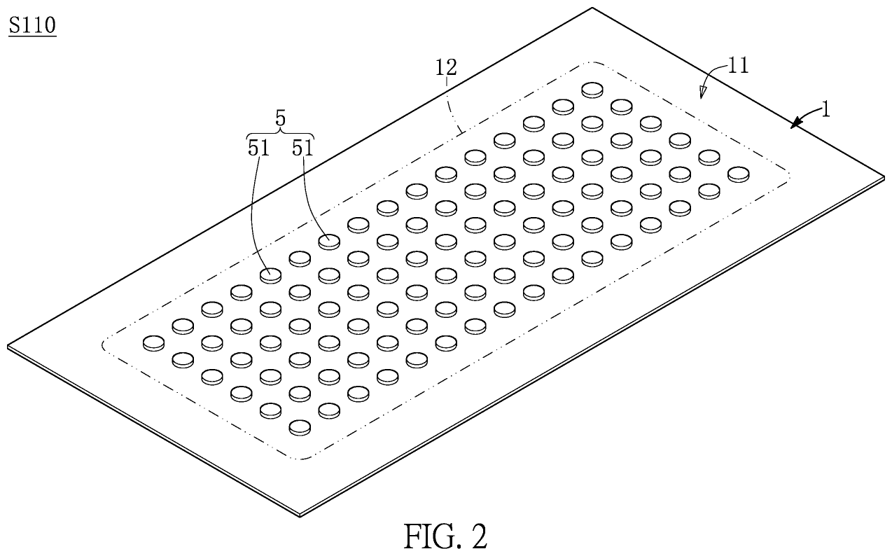

As shown in FIG. 1 and FIG. 2, the surface treatment step S110 is implemented by using a surface treatment process on an inner surface 11 of a first metallic sheet 1 so as to form an active region 12 at the inner surface 11, thereby increasing a hydrophilicity of the inner surface 11 through the active region 12. The first metallic sheet 1 has a flat shape, a ratio of the active region 12 to the inner surface 11 can be adjusted or changed according to design requirements, and the surface treatment process can be preferably limited to a plasma surface treatment process, but the present disclosure is not limited thereto. For example, in other embodiments of the present disclosure, the surface treatment process can be implemented by using other processes different from the plasma surface treatment process.

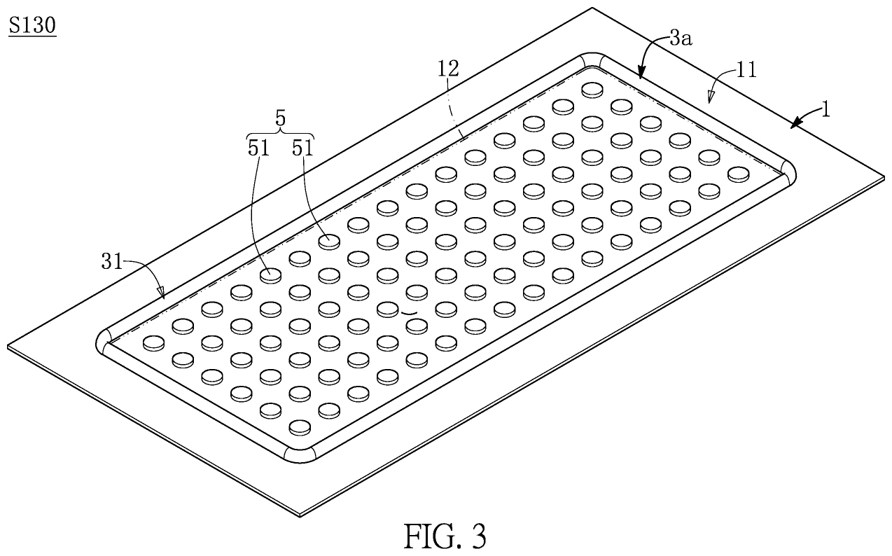

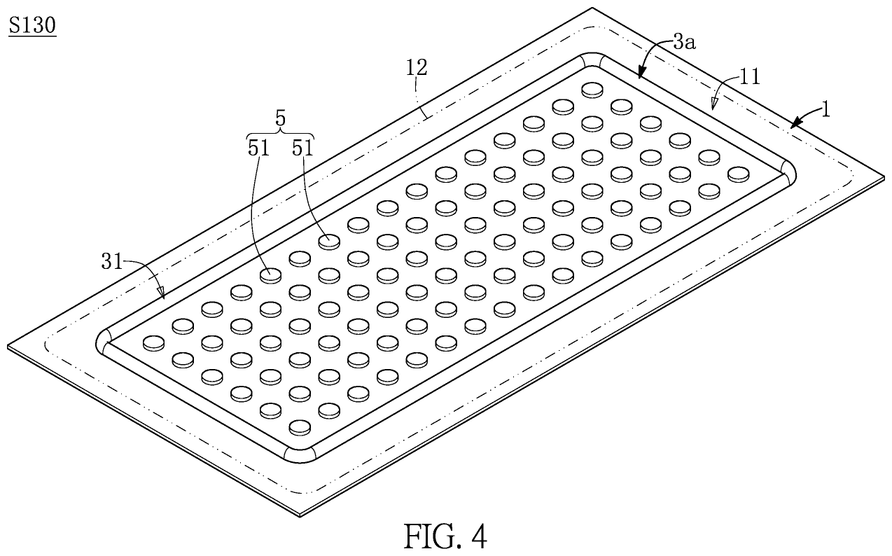

As shown in FIG. 1 and FIG. 3, the dispensing treatment step S130 is implemented by forming a ring-shaped adhesive 3a onto the inner surface 11 of the first metallic sheet 1. The ring-shaped adhesive 3a preferably surrounds at least part of the active region 12. In other words, as shown in FIG. 3, the ring-shaped adhesive 3a can surround an entirely of the active region 12; or, as shown in FIG. 4, the ring-shaped adhesive 3a can surround a part of the active region 12, and another part of the active region 12 is located outside of the ring-shaped adhesive 3a.

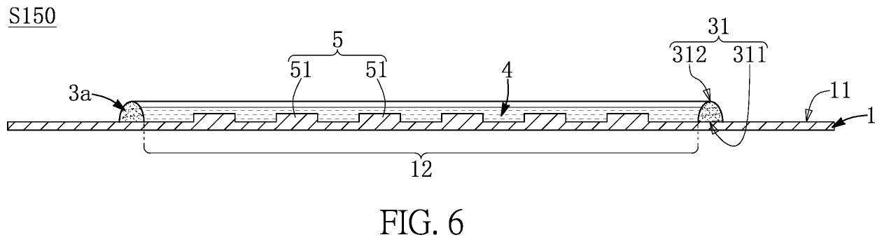

Specifically, the ring-shaped adhesive 3a has two ring-shaped connection surfaces 31 that are respectively arranged on two opposite sides thereof and that are respectively defined as a first ring-shaped connection surface 311 and a second ring-shaped connection surface 312 (shown in FIG. 6). The first ring-shaped connection surface 311 is gaplessly connected to the inner surface 11 of the first metallic sheet 1. It should be noted that the two ring-shaped connection surfaces 31 can have a substantially same size or shape, and the term “ring-shaped” or “ring-shape” of the present embodiment shows a rectangular ring-shape in the drawings and can be changed or adjusted according to design requirements.

In the dispensing step S130 of the present embodiment, a dispensing process is implemented to continuously output an adhesive in a same amount so as to form the ring-shaped adhesive 3a by connecting two opposite ends of the adhesive. The material of the ring-shaped adhesive 3a (or the adhesive) is a viscous polymer that can utilize the polymer chain action to establish a seal effect under a room temperature, and the viscous polymer can be in a single dosage form or a multi dosage form. Moreover, the ring-shaped adhesive 3a (or the adhesive) can further include a plurality of metallic powders (or a metallic material identical to the first metallic sheet 1) embedded in the viscous polymer, so that the metallic powders can be gathered and connected to from a heat-dissipation surface, but the present disclosure is not limited thereto.

Specifically, the material of the ring-shaped adhesive 3a (or the adhesive) preferably excludes any solder, in other words, any vapor chamber manufacturing method using solders or having a soldering step is different from the manufacturing method S100 of the present embodiment.

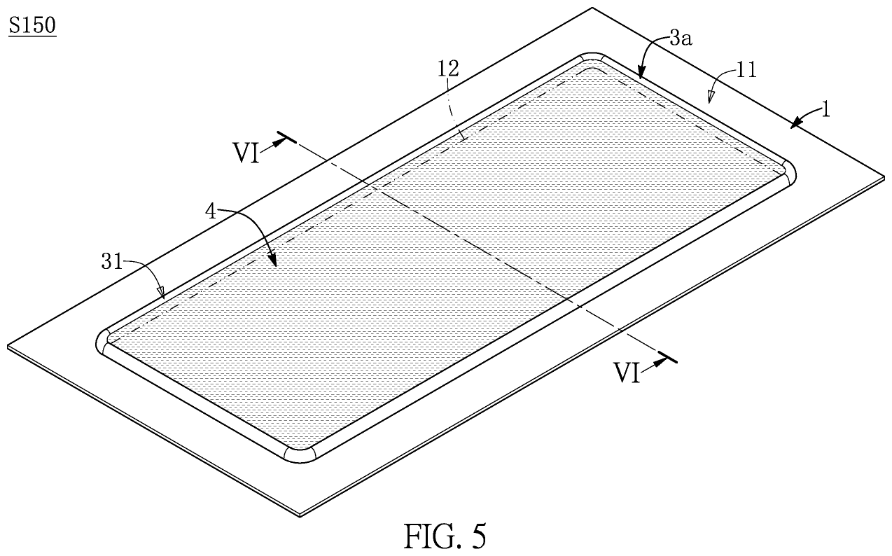

As shown in FIG. 1, FIG. 5, and FIG. 6, the filling step S150 is implemented by filling a working liquid 4 in a space jointly surrounded by the ring-shaped adhesive 3a and the inner surface 11 of the first metallic sheet 1. The working liquid 4 is in contact with the active region 12 that is arranged inside of the ring-shaped adhesive 3a and that is hydrophilic. Specifically, the working liquid 4 comes in contact with the hydrophilic active region 12 to be in a flattened state, and an outer surface of the working liquid 4 is lower than the ring-shaped connection surface 31 (e.g., the second ring-shaped connection surface 312) of the ring-shaped adhesive 3a arranged away from the first metallic sheet 1 with respect to the inner surface 11.

In the filling step S150 of the present embodiment, the working liquid 4 can be filled in a spraying manner, a blading manner, or a slit coating manner, thereby facilitating to enable the working liquid 4 to be flattened (e.g., the outer surface of the working liquid 4 is substantially parallel to the inner surface 11 of the first metallic sheet 1), but the present disclosure is not limited thereto.

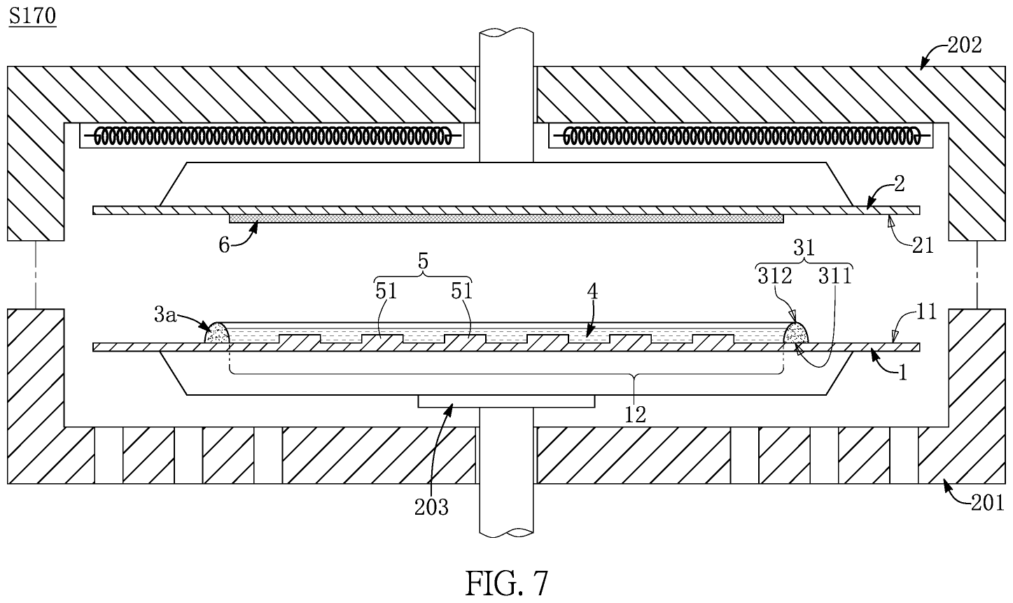

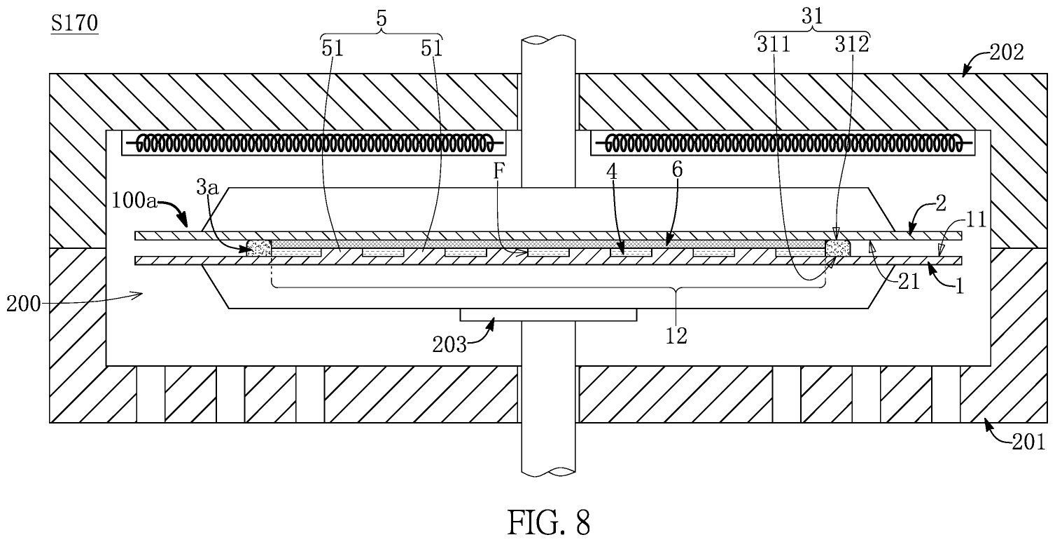

As shown in FIG. 1, FIG. 7, and FIG. 8, the bonding step S170 is implemented by using the ring-shaped adhesive 3a to bond the first metallic sheet 1 and a second metallic sheet 2 together in a vacuum chamber 200, so as to form a semi-finished product 100a and to jointly define an enclosed thermal flow space F that accommodates the working liquid 4 therein.

It should be noted that in the bonding step S170 of the present embodiment, the connection between the first metallic sheet 1 and the second metallic sheet 2 is established by using the two ring-shaped connection surfaces 31 of the ring-shaped adhesive 3a to be gaplessly connected to the first metallic sheet 1 and the second metallic sheet 2, respectively. In other words, the second metallic sheet 2 is gaplessly connected to the second ring-shaped connection surface 312 of the ring-shaped adhesive 3a.

Moreover, the bonding step S170 is implemented in the vacuum chamber 200 (e.g., the first metallic sheet 1 and the second metallic sheet 2 are located in the vacuum chamber 200 having a predetermined vacuum value and are pressed against each other), so that the thermal flow space F of the semi-finished product 100a has the predetermined vacuum value and does not need to additionally have any gas suction. The predetermined vacuum value of the vacuum chamber 200 is preferably less than 50 Pa (e.g., the predetermined vacuum value can be less than 15 Pa), but the present disclosure is not limited thereto. For example, in other embodiments of the present disclosure, the predetermined vacuum value of the vacuum chamber 200 can be adjusted or changed according to design requirements.

Specifically, the vacuum chamber 200 of the present embodiment can be provided in various configurations, and the following description describes the vacuum chamber 200 having a preferable one configuration for clearly describing the present embodiment, but the present disclosure is not limited thereto. The vacuum chamber 200 of the present embodiment can be provided as follows. A first pressing mechanism 201 and a second pressing mechanism 202 face toward each other and are connected to each other, and an interior thereof is implemented by performing a gas suction process to form the vacuum chamber 200. In other words, the interior of the first pressing mechanism 201 and the second pressing mechanism 202 has a pressure value that decreases from an atmospheric pressure value to the predetermined vacuum value (e.g., the pressure value is less than 15 Pa) through the gas suction process.

The gas suction process has multiple suction rates that are different from each other, and at least one of the first pressing mechanism 201 and the second pressing mechanism 202 preferably includes an aligning module 203 (e.g., a horizontal displacement mechanism), thereby enabling to precisely control the relative position between the first pressing mechanism 201 and the second pressing mechanism 202, but the present disclosure is not limited thereto. For example, in other embodiments of the present disclosure, the gas suction process can have only one of the suction rates; or, the aligning module 203 can be omitted or can be replaced by other components.

Specifically, in the bonding step S170 of the present embodiment, the first metallic sheet 1 and the components thereon are disposed on the first pressing mechanism 201, and the second metallic sheet 2 is disposed on the second pressing mechanism 201 and faces toward the ring-shaped adhesive 3a on the first metallic sheet 1. When the first pressing mechanism 201 and the second pressing mechanism 202 are connected to each other and a gas suction process is performed in the interior thereof to form the vacuum chamber 200, the first metallic sheet 1 and the second metallic sheet 2 are pressed against each other by the first pressing mechanism 201 and the second pressing mechanism 202 so as to be bonded with each other to form the semi-finished product 100a. Moreover, the first metallic sheet 1 and the second metallic sheet 2 are preferably adjusted to a predetermined relative position through the aligning module 203 before being bonded with each other.

As shown in FIG. 1 and FIG. 9 to FIG. 11, the solidifying step S190 is implemented by placing the semi-finished product 100a in a solidifying environment to solidify the ring-shaped adhesive 3a, so as to form a sealing frame 3. In the solidifying of the ring-shaped adhesive 3a, the first metallic sheet 1 and the second metallic sheet 2 can be pressed continuously so as to abut against the ring-shaped adhesive 3a, or can be just in contact with the ring-shaped adhesive 3a. In the solidifying step S190 of the present embodiment, the ring-shaped adhesive 3a is solidified to form the sealing frame 3 by performing a thermal solidifying process (e.g., the first pressing mechanism 201 or the second pressing mechanism 202 can be provided with a heater therein), but the present disclosure is not limited thereto. For example, in other embodiments of the present disclosure, the semi-finished product 100a is removed from the vacuum chamber 200, and then is placed in an oven for baking and curing; or, the solidifying step S190 can be implemented by performing other processes (e.g., a curing process by reacting water and oxygen) different from the thermal solidifying process.

In summary, the vapor chamber 100 having the adhering configuration can be produced after implementing the steps S110-S190 of the manufacturing method S100. Accordingly, the bonding step S170 of the manufacturing method S100 is implemented in the vacuum chamber 200, so that the thermal flow space F of the vapor chamber 100 can have the predetermined vacuum value to facilitate to reduce a boiling point of the working liquid 4 arranged in the thermal flow space F, thereby effectively increasing a heat-dissipation performance of the vapor chamber 100.

In addition, the following description describes the vapor chamber 100 having a preferable one configuration, and the structural design of the vapor chamber 100 can be referred to the above description of the manufacturing method S100.

The vapor chamber 100 of the present embodiment has a flat shape, and includes the first metallic sheet 1, the second metallic sheet 2 facing toward the first metallic sheet 1, the sealing frame 3 connected to the first metallic sheet 1 and the second metallic sheet 2, a supporting structure 5 located between the first metallic sheet 1 and the second metallic sheet 2, a capillary structure 6 located between the first metallic sheet 1 and the second metallic sheet 2, and a working liquid 4, but the present disclosure is not limited thereto. For example, in other embodiments of the present disclosure, the supporting structure 5 and/or the capillary structure 6 of the vapor chamber 100 can be omitted or can be replaced by other components.

Specifically, the first metallic sheet 1 and the second metallic sheet 2 are spaced apart from each other (e.g., the first metallic sheet 1 is not in contact with the second metallic sheet 2), and no thru-hole is formed in the first metallic sheet 1 and the second metallic sheet 2. In other words, any vapor chamber, which includes a metallic plate having a gas hole or an injection hole, is different from the vapor chamber 100 having the adhering configuration of the present embodiment.

In the present embodiment, the supporting structure 5 and the sealing frame 3 are jointly configured to maintain a distance between the first metallic sheet 1 and the second metallic sheet 2, for ensuring the first metallic sheet 1 and the second metallic sheet 2 are spaced apart from each other. The supporting structure 5 includes a plurality of protrusions 51 disposed on an inner surface 11, 21 of at least one of the first metallic sheet 1 and the second metallic sheet 2. Moreover, the sealing frame 3 is ring-shaped, and the two ring-shaped connection surfaces 31 respectively arranged on two opposite sides of the sealing frame 3 are gaplessly connected to the first metallic sheet 1 and the second metallic sheet 2, respectively, so that the sealing frame 3, the first metallic sheet 1, and the second metallic sheet 2 jointly define the enclosed thermal flow space F. The thermal flow space F preferably has a vacuum value less than 50 Pa, but the present disclosure is not limited thereto.

Furthermore, the active region 12 is arranged on the inner surface 11 of the first metallic sheet 1, and the sealing frame 3 surrounds at least part of the active region 12. The protrusions 51, the capillary structure 6, and the working liquid 4 are located in the thermal flow space F. The protrusions 51 abut against the capillary structure 6, and the working liquid 4 is in contact with the active region 12.

### Second Embodiment

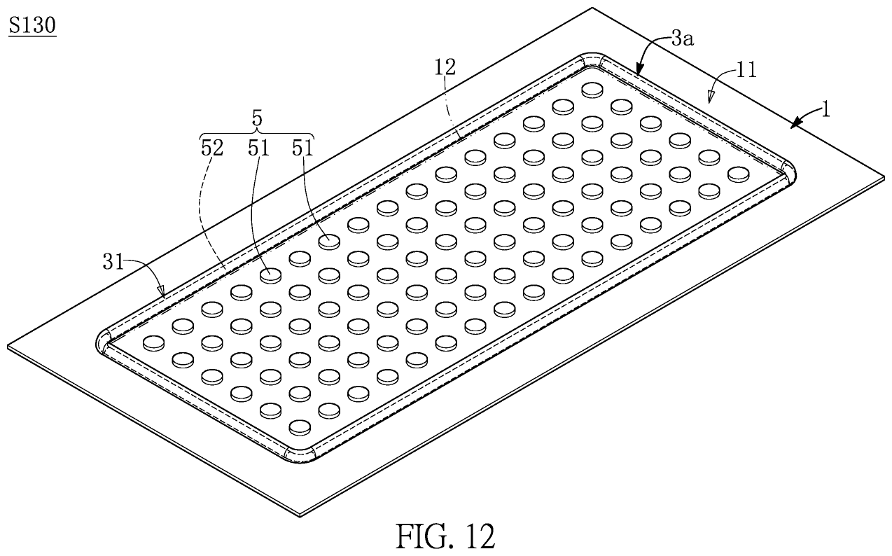

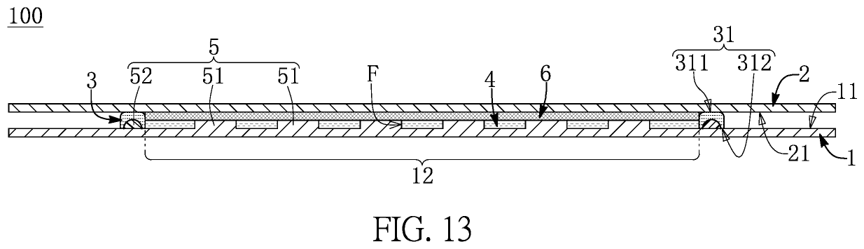

Referring to FIG. 12 and FIG. 13, a second embodiment of the present disclosure is provided, which is similar to the first embodiment of the present disclosure. For the sake of brevity, descriptions of the same components in the first and second embodiments of the present disclosure will be omitted herein, and the following description only discloses different features between the first and second embodiments.

In the present embodiment, a supporting frame 52 being in a ring-shaped arrangement is disposed on the inner surface 11 of the first metallic sheet 1. In other words, the supporting structure 5 in the present embodiment includes the protrusions 51 arranged in the thermal flow space F and the supporting frame 52 that surrounds the protrusions 51. Specifically, the supporting frame 52 can be a single ring-shaped frame; or, in other embodiments of the present disclosure not shown in the drawings, the supporting frame 52 can include a plurality of ribs being in a ring-shaped arrangement, but the present disclosure is not limited thereto.

In addition, the ring-shaped adhesive 3a in the dispensing step S130 of the present embodiment is formed on the inner surface 11 of the first metallic sheet 1 along the supporting frame 52. Accordingly, the sealing frame 3 is formed on the supporting frame 52 (e.g., the supporting frame 52 is embedded in the sealing frame 3), so that the ring-shaped adhesive 3a or the sealing frame 3 can have a more stable structure through the supporting frame 52, but the present disclosure is not limited thereto. For example, in other embodiments of the present disclosure, the ring-shaped adhesive 3a or the sealing frame 3 can be connected to a top side of the supporting frame 52 so as to be sandwiched between the supporting frame 52 and the second metallic sheet 2.

### Beneficial Effects of the Embodiments

In conclusion, the manufacturing method of the vapor chamber having the adhering configuration provided by the present disclosure is implemented by using the ring-shaped adhesive to bond the first metallic sheet and the second metallic sheet in the vacuum chamber, so that the thermal flow space can be maintained at a low pressure value (e.g., a value less than 50 Pa). Accordingly, gas suction does not need to be performed in the thermal flow space of the vapor chamber, thereby effectively simplifying the existing processes and structures relating to the conventional vapor chamber.

Moreover, in the vapor chamber having the adhering configuration provided by the present disclosure, the first metallic sheet and the second metallic sheet can be bonded by being gaplessly connected to the sealing frame, thereby simplifying the existing structure, effectively reducing a material and manufacturing cost, and increasing a production effectiveness thereof.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A manufacturing method of a vapor chamber having an adhering configuration, comprising:
a dispensing step implemented by forming a ring-shaped adhesive onto an inner surface of a first metallic sheet;
a filling step implemented by filling a working liquid in a space jointly surrounded by the ring-shaped adhesive and the inner surface of the first metallic sheet;
a bonding step implemented by using the ring-shaped adhesive to bond the first metallic sheet and a second metallic sheet together in a vacuum chamber, so as to form a semi-finished product and to jointly define an enclosed thermal flow space that accommodates the working liquid therein; and
a solidifying step implemented by placing the semi-finished product in a solidifying environment to solidify the ring-shaped adhesive, so as to form a sealing frame.

2. The manufacturing method according to claim 1, wherein before the dispensing step, the manufacturing method further includes a surface treatment step implemented by performing a surface treatment process on the inner surface of the first metallic sheet so as to form an active region at the inner surface, wherein in the dispensing step, the ring-shaped adhesive surrounds at least part of the active region, and wherein in the filling step, the working liquid is in contact with the active region.

3. The manufacturing method according to claim 2, wherein in the surface treatment step, the surface treatment process is limited to being a plasma surface treatment process.

4. The manufacturing method according to claim 2, wherein in the filling step, the working liquid comes in contact with the active region to be in a flattened state, and an outer surface of the working liquid is lower than a ring-shaped connection surface of the ring-shaped adhesive arranged away from the first metallic sheet.

5. The manufacturing method according to claim 1, wherein a supporting frame being in a ring-shaped arrangement is disposed on the inner surface of the first metallic sheet, and wherein in the dispensing step, the ring-shaped adhesive is formed on the inner surface along the supporting frame.

6. The manufacturing method according to claim 1, wherein in the dispensing step, a dispensing process is implemented to continuously output an adhesive in a same amount so as to form the ring-shaped adhesive by connecting two opposite ends of the adhesive.

7. The manufacturing method according to claim 1, wherein in the filling step, a filling manner for the working liquid is a spraying manner, a blading manner, or a slit coating manner.

8. The manufacturing method according to claim 1, wherein in the bonding step, the ring-shaped adhesive has two ring-shaped connection surfaces that are respectively arranged on two opposite sides thereof and that are gaplessly connected to the first metallic sheet and the second metallic sheet, respectively.

9. The manufacturing method according to claim 1, wherein in the bonding step, a predetermined vacuum value of the vacuum chamber is less than 50 Pa, and the thermal flow space has the predetermined vacuum value.

10. The manufacturing method according to claim 1, wherein in the bonding step, the first metallic sheet is disposed on a first pressing mechanism, the second metallic sheet is disposed on a second pressing mechanism and faces toward the ring-shaped adhesive on the first metallic sheet, and wherein, when the first pressing mechanism and the second pressing mechanism are connected to each other and a gas suction process is performed in an interior thereof to form the vacuum chamber, the first metallic sheet and the second metallic sheet are pressed against each other by the first pressing mechanism and the second pressing mechanism so as to be bonded with each other to form the semi-finished product.

11. The manufacturing method according to claim 10, wherein in the bonding step, the interior of the first pressing mechanism and the second pressing mechanism has a pressure value that decreases from an atmospheric pressure value to a predetermined vacuum value through the gas suction process, and the first metallic sheet and the second metallic sheet are located in the vacuum chamber having the predetermined vacuum value and are pressed against each other.

12. The manufacturing method according to claim 11, wherein in the bonding step, the gas suction process has multiple suction rates that are different from each other.

13. The manufacturing method according to claim 10, wherein in the bonding step, at least one of the first pressing mechanism and the second pressing mechanism includes an aligning module, and the first metallic sheet and the second metallic sheet are adjusted to a predetermined relative position through the aligning module before being bonded with each other.

14. The manufacturing method according to claim 1, wherein in the bonding step, the ring-shaped adhesive is solidified to form the sealing frame by performing a thermal solidifying process.

15. A vapor chamber having an adhering configuration, comprising:
a first metallic sheet;
a second metallic sheet facing toward and spaced apart from the first metallic sheet;
a sealing frame being ring-shaped and having two ring-shaped connection surfaces that are respectively arranged on two opposite sides thereof, wherein the two ring-shaped connection surfaces are gaplessly connected to the first metallic sheet and the second metallic sheet, respectively, so that the sealing frame, the first metallic sheet, and the second metallic sheet jointly define an enclosed thermal flow space; and
a working liquid located in the thermal flow space.

16. The vapor chamber according to claim 15, wherein the vapor chamber has a flat shape.

17. The vapor chamber according to claim 15, further comprising:
a supporting structure located between the first metallic sheet and the second metallic sheet, wherein the supporting structure and the sealing frame are jointly configured to maintain a distance between the first metallic sheet and the second metallic sheet; and
a capillary structure arranged in the thermal flow space.

18. The vapor chamber according to claim 17, wherein the supporting structure is arranged on an inner surface of at least one of the first metallic sheet and the second metallic sheet, the supporting structure includes a plurality of protrusions arranged in the thermal flow space and a supporting frame that surrounds the protrusions, and the sealing frame is formed on the supporting frame.

19. The vapor chamber according to claim 15, wherein an inner surface of the first metallic sheet has an active region, the sealing frame surrounds at least part of the active region, and the working liquid is in contact with the active region.

20. The vapor chamber according to claim 15, wherein the first metallic sheet is not in contact with the second metallic sheet, and no thru-hole is formed in the first metallic sheet and the second metallic sheet.
